(19) United States
(12) Patent Application Publication
(10) Pub. No.: US 2024/0407425 A1
(43) Pub. Date: Dec. 12, 2024

(54) ENCAPSULATED FLAVOUR IN AEROSOL-GENERATING MATERIAL

(71) Applicant: Nicoventures Trading Limited, London (GB)

(72) Inventors: David BISHOP, London (GB); Biniam TESFATSION, London (GB)

(21) Appl. No.: 18/702,572

(22) PCT Filed: Oct. 19, 2022
(86) PCT No.: PCT/GB2022/052662

§ 371 Date: Apr. 18, 2024

(30) Foreign Application Priority Data
Oct. 19, 2021 (GB) 2114908.3

(51) Int. Cl. A24B 15/28; A24B 3/12; A24B 15/10; A24B 15/30; A24B 15/32; A24B 15/40; A24B 15/42

(52) U.S. Cl. CPC A24B 15/283; A24B 3/12; A24B 15/10; A24B 15/302; A24B 15/32; A24B 15/403; A24B 15/42

(57) ABSTRACT

This invention relates to an aerosol-generating material for use in an aerosol provision system, the aerosol-generating material having embedded therein a flavour encapsulated in an encapsulating material.

### FIELD

This invention relates to an aerosol-generating material for use in an aerosol provision system, and also relates to a method, to a consumable and to a use of an encapsulated flavour.

### BACKGROUND

The inventors have found that current methods of adding flavour to aerosol-generating materials for tobacco heated products commonly provide inadequate provision of flavour to the user. For example, the flavour delivery may be too fast to provide the desired effect. A common method to produce such flavoured aerosol-generating materials include infusing the aerosol-generating material via simple adsorption by submerging the material in liquid flavour. This suffers the problem that the flavour is poorly taken up by the aerosol-generating material leading to a weak flavour. The flavour may also be released too quickly, for example the favour may be released within about 20 puffs as flavour is poorly retained. Other problems that are sought to be overcome include cross contamination from processes and stability issues. Thus there is a need to produce an aerosol-generating material which retains menthol adequately for the user and releases it in a timely manner.

### SUMMARY

According to a first aspect of the invention, there is provided an aerosol-generating material for use in an aerosol provision system, the aerosol-generating material having embedded therein a flavour encapsulated in an encapsulating material.

In some embodiments, the aerosol-generating material is extruded, agglomerated or granulated to embed the encapsulated flavour therein.

In some embodiments, the encapsulated flavour is menthol.

In some embodiments, the encapsulated flavour is selected from dried vanilla, apple, amaretto, tiramisu, fruit of forest and mango.

In some embodiments, the flavour is encapsulated in the encapsulating material by spray-drying.

In some embodiments, the encapsulating material comprises a stabiliser.

In some embodiments, the encapsulating material comprises a gum material, optionally wherein the gum material is acacia gum.

In some embodiments, the encapsulating material comprises one or more matrix-forming material selected from the group consisting of: sugar alcohols; carbohydrates; polymers such as gelatin, agar, PEG 2000-6000 and polyvinylpyrrolidone (PVP) (10k);

and long chain fatty acids. In some embodiments, the matrix-forming material comprises sorbitol.

In some embodiments, the encapsulating material is cyclodextrin. In some embodiments, the cyclodextrin is β-cyclodextrin or γ-cyclodextrin.

In some embodiments, the aerosol-generating material comprises a nicotine source, optionally wherein the nicotine source is tobacco.

In some embodiments, the aerosol-generating material comprises a binder, optionally wherein the binder is selected from the group consisting of CMC, polysaccharides including natural gums (locust bean gum, xanthan gum, gum arabic, agar, alginic acid, carrageenan, guar gum, gellan gum, karaya gum), starch (both natural and modified), alginates, cellulosic materials (natural and modified including HPC, HMPC, HEC), chitosan.

In some embodiments, the aerosol-generating material comprises a pH modifier, optionally wherein the pH modifier is Na₂CO₃.

In some embodiments, the aerosol-generating material comprises an aerosol-former, which is optionally selected from erythritol, propylene glycol, glycerol, vegetable glycerine (VG), triacetin, and xylitol.

According to a second aspect of the invention there is provided a method for manufacturing an aerosol-generating material according to the first aspect, comprising encapsulating a flavour in an encapsulation material and extruding, agglomerating or granulating the encapsulated flavour to form the aerosol-generating material.

In some embodiments, the encapsulated flavour is extruded with a nicotine source, optionally tobacco.

In some embodiments, the flavour is spray dried with the encapsulating material.

In some embodiments, the encapsulating material comprises 35-55% by weight of a stabiliser and/or 35-55% by weight of a gum material and/or 5-35% by weight of matrix-forming material.

In some embodiments, the encapsulated flavour comprises 30-65% by weight of the flavour.

According to a third aspect of the invention there is provided a consumable for use in an aerosol provision system comprising the aerosol-generating material according to the first aspect.

According to a fourth aspect of the invention there is provided use of an encapsulated flavour embedded in an aerosol-generating material to control the release of the flavour over 25 or more puffs generated by heating the aerosol-generating material in an aerosol provision system.

### BRIEF DESCRIPTION OF THE DRAWINGS

Embodiments of the invention will now be described, by way of example only, with reference to accompanying drawings, in which:

FIG. 1 is a Thermogravimetric Analyzer (TGA) profile of unencapsulated menthol (denoted as “pure menthol”) compared to that of spray-dried menthol. The profile was hold at 30° C. for 1 minute followed by a ramping stage at 10° C./min until a temperature of 500° C. is attained.

FIG. 2 is a graph showing the aerosol menthol delivery (μg/puff) for spray dried tobacco.

FIG. 3 is a perspective illustration of a non-combustible aerosol provision device for generating aerosol from the aerosol-generating material described herein.

FIG. 4 is a Thermogravimetric Analyzer (TGA) profile of unencapsulated menthol (denoted as “menthol”) compared to that of menthol encapsulated in an encapsulation material comprising β-cyclodextrin (denoted as “BCD-menthol complex”), and that of β-cyclodextrin alone (denoted as “BCD”).

### DETAILED DESCRIPTION

This invention relates to an aerosol-generating material for use in an aerosol provision system, the aerosol-generating material having embedded therein a flavour encapsulated in an encapsulating material. In some embodiments, the aerosol-generating material is extruded, agglomerated or granulated to embed the encapsulated flavour within it. Other techniques or processes may be used to incorporate the encapsulated flavour into the structure of the aerosol-generating material.

The aerosol-generating material described herein enjoys the advantage that the aerosol-generating material retains and protects the flavour more than other flavoured aerosol-generating materials. This provides a better flavour profile, consistent and slower release and a specific release profile. This provides the user with a strong, sustained and enduring flavour. The inventors have found that the combination of the encapsulated flavour and structurally embedding the encapsulated flavour into the aerosol-generating material, for example by extrusion, agglomeration or granulation, optionally with spheronisation, provides a particularly well protected flavour which affords the aforementioned release profile and flavour advantages.

Another advantage is that the aerosol-generating materials are stable at a range of temperatures and humidities and have an increased shelf-life, and are therefore easy to store and transport. The loss of flavour over time is reduced. The migration of the encapsulated flavour within the aerosol-generating material is also reduced.

The water content of the aerosol-generating material described herein may vary according to, for example, the temperature, pressure and humidity conditions at which the compositions are maintained. The water content can be determined by Karl-Fisher analysis or by gas chromatography-thermal conductivity detector (GC-TCD), as known to those skilled in the art.

### Encapsulation

The flavour is encapsulated to produce an encapsulated flavour. This has the advantage that the flavour is more stable and is easier to process, for example loss of flavour is reduced whilst handling, the encapsulated flavour provides better physical properties and reduced flavour contamination. This is particularly advantageous as there is a second processing step involved (extrusion, agglomeration or granulation) in the production of the aerosol-generating material. The encapsulated flavour is protected from the second process itself, as well as being “double protected” from external influences.

In some embodiments, the encapsulated flavour comprises at least one flavour and an encapsulating material.

The encapsulated flavour may comprise from about 10 to about 80 wt % flavour based on the total weight of the encapsulated flavour. In some embodiments, the encapsulated flavour comprises from about 20 to about 70 wt %, from about 25 to about 65 wt %, from about 30 to about 60 wt % or from about 25 to about 55 wt % flavour. In some embodiments, the encapsulated flavour comprises flavour in an amount from about 30 to about 65% by weight. The amount of flavour may be selected to provide the user with a suitable flavour release profile over time, such that an adequate amount of flavour is supplied, without it being too strong or weak.

As used herein, the terms “flavour” and “flavourant” refer to materials which, where local regulations permit, may be used to create a desired taste, aroma or other somatosensorial sensation in a product for adult consumers. They may include naturally occurring flavour materials, botanicals, extracts of botanicals, synthetically obtained materials, or combinations thereof (e.g., tobacco, cannabis, licorice (liquorice), hydrangea, eugenol, Japanese white bark magnolia leaf, chamomile, fenugreek, clove, maple, matcha, menthol, Japanese mint, aniseed (anise), cinnamon, turmeric, Indian spices, Asian spices, herb, wintergreen, cherry, berry, red berry, cranberry, peach, apple, orange, mango, clementine, lemon, lime, tropical fruit, papaya, rhubarb, grape, durian, dragon fruit, cucumber, blueberry, mulberry, citrus fruits, Drambuie, bourbon, scotch, whiskey, gin, tequila, rum, spearmint, peppermint, lavender, aloe vera, cardamom, celery, cascarilla, nutmeg, sandalwood, bergamot, geranium, khat, naswar, betel, shisha, pine, honey essence, rose oil, vanilla, lemon oil, orange oil, orange blossom, cherry blossom, cassia, caraway, cognac, jasmine, ylang-ylang, sage, fennel, wasabi, piment, ginger, coriander, coffee, hemp, a mint oil from any species of the genus Mentha, eucalyptus, star anise, cocoa, lemongrass, rooibos, flax, Ginkgo biloba, hazel, hibiscus, laurel, mate, orange skin, rose, tea such as green tea or black tea, thyme, juniper, elderflower, basil, bay leaves, cumin, oregano, paprika, rosemary, saffron, lemon peel, mint, beefsteak plant, curcuma, cilantro, myrtle, cassis, valerian, pimento, mace, damien, marjoram, olive, lemon balm, lemon basil, chive, carvi, verbena, tarragon, limonene, thymol, camphene), flavour enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, liquid such as an oil, solid such as a powder, or gas.

In some embodiments, the flavour is volatile or otherwise prone to migration when incorporated into an aerosol-generating material.

In some embodiments, the flavour comprises menthol, spearmint and/or peppermint. In some embodiments, the flavour may comprise, consist essentially of or consist of menthol.

In some embodiments, the flavour comprises flavour components of cucumber, blueberry, citrus fruits and/or redberry. In some embodiments, the flavour comprises eugenol. In some embodiments, the flavour comprises flavour components extracted from tobacco. In some embodiments, the flavour comprises flavour components extracted from cannabis.

In some embodiments, the flavour may comprise a sensate, which is intended to achieve a somatosensorial sensation which are usually chemically induced and perceived by the stimulation of the fifth cranial nerve (trigeminal nerve), in addition to or in place of aroma or taste nerves, and these may include agents providing heating, cooling, tingling, numbing effect. A suitable heat effect agent may be, but is not limited to, vanillyl ethyl ether and a suitable cooling agent may be, but not limited to eucolyptol, WS-3.

### Encapsulation Material

In some embodiments, the flavour is encapsulated in a composition, herein denoted as “encapsulation material”.

In some embodiments, the encapsulation material forms a matrix or coating that surrounds the flavour. The flavour may be distributed throughout all or part of the encapsulating material. Alternatively, the encapsulation material may form a coating or shell the surrounds the flavour. In some embodiments, the encapsulation material is a molecular framework, such as a metal-organic framework, having a cavity within which the flavour molecule is held.

The encapsulation material immobilises the flavour and protects it.

The encapsulation material may comprise at least one matrix-forming material selected from the group consisting of: sugar alcohols, such as sorbitol, mannitol; carbohydrates (including mono-, di- and oligo-saccharides) such as starches, sucrose, trehalose, lactose, raffinose, maltose, Dextran 10, Dextran 70, Dextran 90, maltodextrin, and cyclodextrin; polymers such as gelatin, agar, PEG 2000-6000 and polyvinylpyrrolidone (PVP) (10k); long chain fatty acids, or combinations thereof.

These matrix-forming materials may act as a bulking agent or a filler material and may also form a matrix or coating. The encapsulation material may comprise about 5-85 wt %, about 10-700 wt %, about 15-60 wt %, or about 20-50 wt % of the matrix-forming material. In some embodiments, the encapsulation material comprises 5-50% by weight of the matrix-forming material. In some embodiments, the encapsulation material may comprise about 18 wt % of the matrix-forming material. The amount of the matrix-forming material in the encapsulation material may vary and may be selected depending on the nature of the flavour to be encapsulated as well as the other components of the encapsulation material and the aerosol-generating material.

In some embodiments, the matrix-forming material has hydrophilic properties. This provides the advantage that they can easily disperse in an aqueous environment, and protect any mostly hydrophobic ingredients being encapsulated. Sorbitol or other sugar alcohols may be particularly suitable in embodiments in which a slurry is prepared prior to spray-drying. In embodiments in which the matrix-forming material is sorbitol, the encapsulation material may comprise 5-50% by weight of the matrix-forming material.

The encapsulation material may comprise a gum material, for example cellulosic gelling agents and non-cellulosic gelling agents, such as guar gum, acacia gum and mixtures thereof. The encapsulation material may comprise about 20-70 wt %, about 30-60 wt %, about 35-55 wt %, about 30-50 wt % or about 35-45 wt % gum material. In some embodiments, the encapsulation material comprises 35-55% by weight of the gum material. In some embodiments, the encapsulation material may comprise about 40 wt % gum material. The encapsulation material may consist of or consist essentially of the gum material. A gum material advantageously may provide improved protection of the flavour. Without wishing to be bound by reason, it is thought that the gum material has emulsifying properties. In embodiments in which the flavour has hydrophobic characteristics, a gum material may help to separate the flavouring from an aqueous environment to which it may be exposed. As described herein, such an aqueous environment may be humidity or during manufacture.

The encapsulation material may comprise a stabiliser, which stabilises and preserves the encapsulation material. The stabiliser advantageously aids maintaining an even dispersion of the components of the encapsulation material in the system. Without wishing to be bound by reason, it is thought that the stabiliser provides a surface energy barrier, without which the dispersed encapsulation system will be less stable. The encapsulation material may comprise about 20-70 wt %, about 30-60 wt %, about 35-55 wt %, about 30-50 wt % or about 35-45 wt % stabiliser. In some embodiments, the encapsulation material comprises 35-55% by weight of the stabiliser. In some embodiments, the encapsulation material may comprise about 40 wt % stabiliser. The stabiliser advantageously stabilises the encapsulation material, and further stabilises the aerosol-generating material after extrusion, granulation and/or spheronisation. The encapsulation material may comprise at least one stabiliser selected from the group of, polysaccharides, natural gums (including locust bean gum, xanthan gum, gum arabic, agar, alginic acid, carrageenan, guar gum, gellan gum, karaya gum), starch (both natural and modified), alginates, cellulosic materials (natural and modified, including HPC, HMPC, HEC), chitosan, emulsifiers (including lecithin, sorbitan esters, sucrose esters, glycerides, and glucosides) or combinations thereof.

In some embodiments, the flavour is encapsulated by molecular encapsulation. The encapsulation material may comprise a molecular encapsulant suitable for such encapsulation. The molecular encapsulant may comprise at least one selected from the group of macrocyclic oligomers, such as cyclodextrins, cucurbiturils, fullerenes, dendrimers, cryptands, calixarenes, pillararenes, resorcinarenes, spherands, and crown ethers, or combinations thereof.

In some embodiments, the encapsulation material comprises at least one cyclodextrin. The cyclodextrin may comprise at least one of β-cyclodextrin or γ-cyclodextrin. The cavity size of the cyclodextrin affects release (e.g. β and γ). Cyclodextrin protects the flavour via a mechanism in which the flavour molecule fits in to the cavity of the cyclodextrin. The complexation of the flavour in the cyclodextrin is aided by interactions between the flavour and the cyclodextrin, for example hydroscopic or electrostatic interactions. The use of cyclodextrin as an encapsulating material has the advantage that both temperature and moisture affects the release of the encapsulated flavour. This means that the flavour may be easily released when the aerosol generating device is used in order to deliver the flavour to the user.

### Encapsulation Methods

In some embodiments, the flavour is encapsulated via spray-drying. In a spray-drying process, the encapsulation material is sprayed and rapidly dried using a hot gas. The use of spray drying provides several advantages to the present invention: the dry particle size can be controlled and may be consistent; if the flavour is heat sensitive it can still be spray-dried at relatively high inlet temperatures; a short residence time in the spray-drying equipment is required; and minimal loss of flavour/volatiles. This makes the process adaptable to reduce loss of volatile compounds and maintain the desired flavour of the aerosol-generating material.

The spray drying process also enjoys the advantage of providing a physical barrier. This is useful when there is a pH change in the environment that would be detrimental to the flavour. For example, nicotine delivery from tobacco is known in the art to be improved at higher pH conditions. The encapsulated flavour may therefore be exposed to high pH conditions when it is included in the aerosol-generating material, and this method protects the flavour from this change.

Encapsulated flavour may also be prepared by granulation. This may be particularly appropriate for a flavour in solid form. Granulation involves the agglomeration of fine particles or powders into larger granules or grains. The particles are collected together and may be bonded to one another by compression or using a binding agent. Granulation may be a wet process or a dry process.

Molecular encapsulation may be employed in some embodiments. Molecular encapsulation is the method in which a “guest” molecule is confined inside the cavity of a “host molecule”. These host molecules may consist of a molecular capsule, a molecular container, cage compounds, crown ethers, cyclic compounds, cyclodextrins or other supramolecular structures for example. An advantage of molecular encapsulation is it provides a controlled & programmable release of the encapsulated flavour. The controlled release can be achieved through a number of parameters, for example including temperature, pH, and solvent polarity.

In some embodiments, the flavour is encapsulated via spray chilling. Spray chilling is the process of solidifying an atomized liquid spray into particles, which may be in the form of microspheres. Methods to perform spray chilling include pressure nozzles, vibrating nozzles, and spinning disc atomizers. This method provides the advantage that the flavour may be dispersed homogeneously throughout the encapsulating material.

Other possible encapsulation processes include granulation, extrusion, spheronisation, emulsification, agglomeration, bandcasting, coacervation (molecular), gelling, and fluidised bed coating.

### Aerosol-Generating Material

The encapsulated flavour may then be incorporated into the aerosol-generating material via any suitable process that embeds or structurally incorporates the encapsulated flavour into the aerosol-generating material. For example, techniques such as extrusion, agglomeration or granulation or a combination thereof may be used. The inclusion of an encapsulated flavour embedded within the structure of an aerosol-generating material has the advantage that this provides an improved control of the release of the flavour. The aerosol-generating material therefore comprises the encapsulated flavour comprising an encapsulation material as described above, including optionally the stabiliser, filler, and/or gum material or a combination thereof. The aerosol-generating material also acts as a flavour carrier during use of an aerosol-generating device.

In some embodiments, the aerosol-generating material may comprise from about 5 wt %, about 10 wt %, about 20 wt %, about 30 wt %, about 40 wt %, about 50 wt %, 60 wt % or 70 wt %, about 80 wt %, about 90 wt %, or 95 wt % of encapsulated flavour. In some embodiments, the aerosol-generating material may comprise at most about 5 wt %, about 10 wt %, about 20 wt %, about 30 wt %, about 40 wt %, about 50 wt %, 60 wt % or 70 wt %, about 80 wt %, about 90 wt %, or 95 wt % of encapsulated flavour. The amount of encapsulated flavour in the aerosol-generating material may be selected to provide the desired effect to the end-user, as well as to be compatible with the manufacturing process used to prepare the aerosol-generating material.

In some embodiments, the flavour may be released over an extended period of use of the aerosol-generating material by heating to generate an aerosol. For example, the flavour may be released in the first 5, 10, 20, 25, 30, 40, 50, 60, 80, or 100 puffs of aerosol generated by heating the aerosol-generating material. In some embodiments, the release of flavour may be released until after the first 5, 10, 15, or 20 puffs. In some embodiments, the flavour may still be released after the first 60 puffs. In some embodiments, the flavour may still be released after the first 100 puffs.

The processes of extrusion, agglomeration or granulation as described herein provide an aerosol-generating material with enhanced flavour stability and this provides improved storage characteristics due to reduced flavour loss.

The invention enjoys the advantage that the flavour is particularly stable and protected as it is first encapsulated, and subsequently extruded, agglomerated, granulated and optionally spheronised. Both these stages combined causes the flavour to be particularly protected within the aerosol-generating material. This provides an improved, slower and more consistent release profile and improves the stability of the flavour.

Advantageously, the flavour release kinetics during use of the aerosol-generating material are also improved and the flavour delivery is more consistent. The aerosol-generating material may be heated during use, and the release of flavour over time is more consistent and provides a desirable flavour profile over time to the user. This is an improvement over other flavoured aerosol-generated materials from which flavour is often released rapidly and/or at the beginning of the profile. This provides a less desirable user experience as the flavour delivery to the user quickly reduces as puffing continues.

A further advantage is that the encapsulated flavour may be distributed evenly throughout the aerosol-generating material. This provides the user with a more consistent flavour release profile.

An aerosol-generating material is a material that is capable of generating aerosol, for example when heated, irradiated or energized in any other way. Aerosol-generating material may, for example, be in the form of a solid, liquid or gel which may or may not contain an active substance and/or flavourants. In some embodiments, the aerosol-generating material may comprise an “amorphous solid”, which may alternatively be referred to as a “monolithic solid” (i.e. non-fibrous). In some embodiments, the amorphous solid may be a dried gel. The amorphous solid is a solid material that may retain some fluid, such as liquid, within it. In some embodiments, the aerosol-generating material may for example comprise from about 50 wt %, 60 wt % or 70 wt % of amorphous solid, to about 90 wt %, 95 wt % or 100 wt % of amorphous solid.

In some embodiments, the aerosol-generating material is free-flowing and/or non-sticky, and this aids handling of the aerosol-generating material. The aerosol-generating material may be in the form of a free-flowing powder. This enjoys several advantages, including consistent particle size and making the material easier to include in downstream processes and in a consumable. In addition, a free flowing powder is easier to produce and handle, and the flow properties are well known and can be used in machinery. A free-flowing powder is also easier to mix with other ingredients.

Extrusion, agglomeration or granulation may be employed to achieve uniformly sized particles of the desired size. The size of the particle affects the release of the flavour and so control and consistency of the particle size is an advantage of this preparation. Without wishing to be bound by any particular theory, smaller granule particles have a greater surface area to volume ratio and they may therefore exhibit enhanced release of tobacco constituents compared to particles of larger sizes. In some embodiments, sieving may be employed to achieve the desired particle size and distribution.

As used herein, the aerosol-generating material may be present on or in a support, to form a substrate. The support may, for example, be or comprise paper, card, paperboard, cardboard, reconstituted material, a plastics material, a ceramic material, a composite material, glass, a metal, or a metal alloy. In some embodiments, the support comprises a susceptor. In some embodiments, the susceptor is embedded within the material. In some alternative embodiments, the susceptor is on one or either side of the material.

The aerosol-generating material may be formed via extrusion. Extrusion may be performed using one of the main classes of extruders: screw, sieve and basket, roll, ram and pin barrel extruders. This has the advantage that this processing combines mixing, conditioning, homogenizing and moulding of the encapsulated flavour composition and other components of the aerosol-generating material. An additional advantage is that the extruded aerosol-generating material provides an even distribution of flavour through the aerosol-generating material. The extrusion process helps to further structurally integrate the flavour into the tobacco substrate and modify the release profile from the material.

The encapsulated flavour may also be incorporated into the aerosol-generating material via granulation. The process of granulation may include agglomeration, crushing, grinding, milling, shredding or formation into pellets. Suitable machinery to create such particles includes, for example, shredders, cutters, or mills, such as hammer mills, roller mills or other types of commercially available milling machinery.

The encapsulated flavour may also be incorporated into the aerosol-generating material via spheronisation (marumerization). The advantage of spheronisation is that the produced particles are of a consistent size. This makes handling, packing and processing the aerosol-generating material easier. In addition, this allows for more accurate quantities of the flavour in the consumable. Advantageously, the particles are in a sphere shape. This can be advantageous for packing in a consumable and providing a favourable air-flow through the consumable and the aerosol-generating device.

In some embodiments, encapsulated flavour may also be incorporated into the aerosol-generating material via a combination of extrusion or granulation and spheronisation. These methods are particularly useful for flavours that are not compatible with some encapsulation materials that are better suited to spray-drying. For example, certain flavours may be not be miscible in certain components of the encapsulation material that are used in embodiments in which the encapsulation material is spray-dried. In addition, these methods operate at lower temperatures, and so are particularly advantageous for embodiments in which flavours or components of the encapsulation material are thermolabile.

In an exemplary embodiment, the encapsulated flavour may be mixed with the other components of the final aerosol-generating material to achieve a homogenised powder that is then extruded, and subsequently granulated or spheronised.

In some embodiments, it may be desirable for the particles to have an average particle size of no greater than about 3 mm, of no greater than 1 mm, of no greater than about 0.5 mm, or to have an average particle size of no greater than about 0.3 mm, when measured by sieving.

In some embodiments, the average particle size is within the range of from about 0.1 to about 3 mm, of from about 0.1 to about 1 mm, of from about 0.1 to about 0.5 mm, of from about 0.1 to about 0.4 mm, or in the range of from about 0.2 to about 0.3 mm. In some embodiments, at least about 90% of the particles will have a particle size within the range of from about 0.1 to about 3 mm, or of from about 0.1 to about 1 mm, or of from about 0.1 to about 0.5 mm. In some embodiments, at least about 90% of the particles will have a particle size within the range of from about 0.1 to about 3 mm, or of from about 0.1 to about 1 mm, or of from about 0.1 to 0.5 mm. In some embodiments, none of the particles have a particle size greater than 5 mm, greater than 4 mm, greater than 2 mm, greater than 1.5 mm, or greater than about 1 mm. In some embodiments, the average particle size is less than 1 mm.

### Other Components of the Aerosol-Generating Material

The aerosol-generating material may comprise a nicotine source and in some embodiments the nicotine source is tobacco material, extract or tobacco-derived material. The tobacco extract or material may be from or may be any type of tobacco and any part of the tobacco plant, including tobacco lamina, stem, stalk, ribs, scraps and shorts or mixtures of two or more thereof. Suitable tobacco extracts or materials include the following types: Virginia or flue-cured tobacco, Burley tobacco, Oriental tobacco, or blends of tobacco materials, optionally including those listed here. The tobacco may be expanded, such as dry-ice expanded tobacco (DIET), or processed by any other means. In some embodiments, the tobacco material may be reconstituted tobacco material. The tobacco may be pre-processed or unprocessed, and may be, for instance, solid stems (SS); shredded dried stems (SDS); steam treated stems (STS); or any combination thereof. The tobacco material may be fermented, cured, uncured, toasted, or otherwise pre-treated. The tobacco material may be provided in the form of cut rag tobacco. The cut rag tobacco can have a cut width of at least 15 cuts per inch (about 5.9 cuts per cm, equivalent to a cut width of about 1.7 mm) for example. The cut rag tobacco can be formed from a mixture of forms of tobacco material, for instance a mixture of one or more of paper reconstituted tobacco, leaf tobacco, extruded tobacco and bandcast tobacco. In some embodiments, the aerosol-generating material may comprise about 50-90 wt %, about 60-80 wt %, or about 65-75 wt % of the nicotine source.

The aerosol-generating material may further comprise one or more active substances and/or flavours, one or more aerosol-former materials, and optionally one or more other functional material.

The aerosol-generating material may also comprise a binder, which has adhesive qualities. In some embodiments, the binding additive is at least one of thermoreversible gelling agents such as polyvinyl alcohol (PVA), gelatin, gums, acacia gum, starches, polysaccharides, pectins, alginates, wood pulp, celluloses, and cellulose derivatives such as carboxymethylcellulose, or a combination thereof. Inclusion of a binder may have the advantage that the wrapper is easier to handle and process. In some embodiments, the binder consists of, or consists essentially of, carboxymethylcellulose. In some embodiments, the aerosol-generating material may comprise about 0.5-4 wt %, about 1-3 wt % or about 1-2 wt % of binder.

The aerosol-generating material may also comprise a pH modifier. In some embodiments, the pH modifier is Na₂CO₃. In some embodiments, the aerosol-generating material may comprise about 1-15 wt %, about 3-12 wt %, about 5-10% or about 7-9 wt % of a pH modifier. A pH modifier can be advantageous in particular to this invention, as the encapsulated flavour will be protected from the pH changes by the encapsulation as further extrusion or granulation, with optional spheronisation. A basic pH is known in the art to provide improved aerosolisation of tobacco components.

In some embodiments, the aerosol-generating material contains a filler component. The filler component is generally a non-tobacco component, that is, a component that does not include ingredients originating from tobacco. In some embodiments, the aerosol-generating material comprises less than 60 wt % of a filler, such as from 1 wt % to 60 wt %, or 5 wt % to 50 wt %, or 5 wt % to 30 wt %, or 10 wt % to 20 wt % on a wet weight basis.

In some embodiments, the aerosol-generating material may have an increased surface area by comprising an inert filler material. Suitable inert fillers may be porous or non-porous.

The filler, if present, may comprise one or more inorganic filler materials such as calcium carbonate, perlite, vermiculite, diatomaceous earth, colloidal silica, magnesium oxide, magnesium sulphate, magnesium carbonate, and suitable inorganic sorbents, such as molecular sieves. The filler may comprise one or more organic filler materials such as wood pulp, hemp fibre, cellulose and cellulose derivatives.

The aerosol-generating material may also comprise an aerosol former material.

The aerosol-former material may comprise one or more constituents capable of forming an aerosol. Advantageously, the aerosol-former may help drive flavours and nicotine from the aerosol-generating material into the aerosol. In some embodiments, the aerosol-former material may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, propylene carbonate, vegetable glycerine (VG), and xylitol.

In some embodiments, the aerosol former comprises one or more polyhydric alcohols, such as propylene glycol, triethylene glycol, 1,3-butanediol and glycerin; esters of polyhydric alcohols, such as glycerol mono-, di- or triacetate; and/or aliphatic esters of mono-, di- or polycarboxylic acids, such as dimethyl dodecanedioate and dimethyl tetradecanedioate. In some embodiments, the aerosol-former material comprises one or more compounds selected from erythritol, propylene glycol, glycerol, vegetable glycerine (VG), triacetin, sorbitol and xylitol. In some embodiments, the aerosol-former material comprises, consists essentially of or consists of glycerol. Glycerol provides a visible aerosol when the aerosol-generation device is used. It is common that consumers like the aerosol generating device to provide a visible aerosol, as this enables the consumer to visualise the product and what they are consuming. This makes glycerol a desirable choice for aerosol former material. Propylene glycol has the benefit that it is a better flavour carrier than glycerol.

A combination of aerosol forming agents may be used, in equal or differing proportions. The aerosol-former material may act as a plasticiser.

In some embodiments, the aerosol-generating material comprises at least about 1 wt %, at least about 5 wt %, at least about 10 wt %, or at least about 20 wt %, aerosol-former material (calculated on a wet weight basis).

In some embodiments, the aerosol-generating material further comprises a preservative. Suitable preservatives would be readily known to the skilled person and would include, for example, those that are safe for use in products producing inhalable aerosols. Examples of preservatives that might be used include: propylene glycol, carvacrol, thymol, L-menthol, 1,8-cineole, phenoxyethanol, PhytoCide, sorbic acid and its salts, sodium hydroxymethylglycinate, ethylhexylglycerin, parabens and vitamins such as vitamin E or vitamin C.

### Consumable

In some embodiments of the invention, the aerosol-generating material is included in a consumable for use in an aerosol provision system.

A consumable is an article comprising or consisting of aerosol-generating material, part or all of which is intended to be consumed during use by a user. A consumable may comprise one or more other components, such as an aerosol-generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor.

In some cases, the consumable has a rod shape and may further comprise a wrapper that circumscribes the wrapper. As used herein, the term “rod” generally refers to an elongate body which may be any suitable shape for use in an aerosol generating assembly. In some cases, the rod is substantially cylindrical.

### Delivery Systems

As used herein, the term “delivery system” is intended to encompass systems that deliver at least one substance to a user, and includes non-combustible aerosol provision systems that release compounds from an aerosol-generating material without combusting the aerosol-generating material, such as electronic cigarettes, tobacco heating products, and hybrid systems to generate aerosol using a combination of aerosol-generating materials.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energised so as to distribute power in the form of heat to an aerosol-generating material or to a heat transfer material in proximity to the exothermic power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

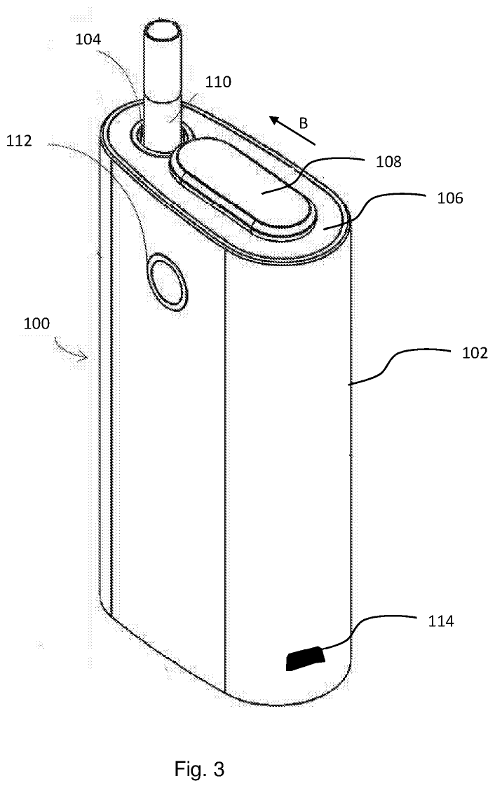

FIG. 3 shows an example of a non-combustible aerosol provision device 100 for generating aerosol from an aerosol-generating material such as the aerosol-generating material of a consumable 110, as described herein. In broad outline, the device 100 may be used to heat a replaceable article 110 comprising the aerosol-generating material, for instance an article as described elsewhere herein, to generate an aerosol or other inhalable medium which is inhaled by a user of the device 100. The device 100 and replaceable article 110 together form a system.

The device 100 comprises a housing 102 (in the form of an outer cover) which surrounds and houses various components of the device 100. The device 100 has an opening 104 in one end, through which the article 110 may be inserted for heating by a heating assembly. In use, the article 110 may be fully or partially inserted into the heating assembly where it may be heated by one or more components of the heater assembly.

The device 100 of this example comprises a first end member 106 which comprises a lid 108 which is moveable relative to the first end member 106 to close the opening 104 when no article 110 is in place. In FIG. 3, the lid 108 is shown in an open configuration, however the lid 108 may move into a closed configuration. For example, a user may cause the lid 108 to slide in the direction of arrow “B”.

The device 100 may also include a user-operable control element 112, such as a button or switch, which operates the device 100 when pressed. For example, a user may turn on the device 100 by operating the switch 112.

The device 100 may also comprise an electrical component, such as a socket/port 114, which can receive a cable to charge a battery of the device 100. For example, the socket 114 may be a charging port, such as a USB charging port.

### Example 1

In a first example, the aerosol-generating material was prepared according to the described steps.

The encapsulated flavour was menthol and the encapsulating material comprised: gum arabic 40%; menthol 42%; and sorbitol 18% (all calculated by weight). Spray-drying was used as the encapsulation method. The average particle size was about 5 to about 125 μm.

The encapsulated flavour was then used to prepare aerosol-generating material comprising: Tobacco 75%; CMC as a binder 1%; the encapsulated flavour 10%; Na₂CO₃ as a pH Modifier 4.3%; water 9.7%. Tobacco leaf was ground to a particle size of 350 μm, and mixed with dry Na₂CO₃ and CMC before being added to a double cone mixer and mixed for 20 minutes. Advantageously, less clumping was observed with the spray-dried menthol in comparison to ground menthol. This mixture was added to an extruder. Water was then added and mixed resulting in the formation of a ‘tobacco dough’ in the extruder. The dough was forced through a die head to form strands and cut into granules using a rotating blade. A seive was then used to select extruded particles having a size from 0.71 to 2 mm. The extruded particles had a median particle size of about 950 to about 1250 μm and density of about 0.75 to about 1 g/cm³.

### Example 2

In a second example, Thermogravimetric Analyzer (TGA) experiments were run. It is known in the art, that positive results in TGA experiments are an indication that the material is likely to perform in similarly positive manner in a THP device.

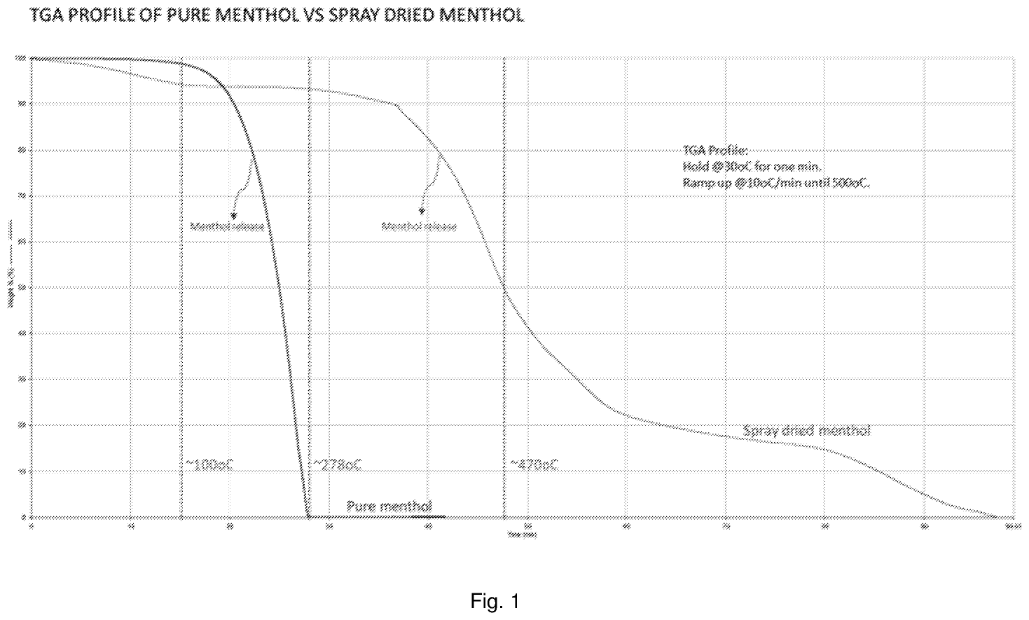

FIG. 1 shows the delay in delivery of the spray dried menthol is substantially longer than that of unencapsulated menthol. Encapsulation of the menthol had an impact on the temperature kinetics and can be used to alter the delivery of the flavourant in a THP device. Both the samples were not extruded, but exemplify the first encapsulation step.

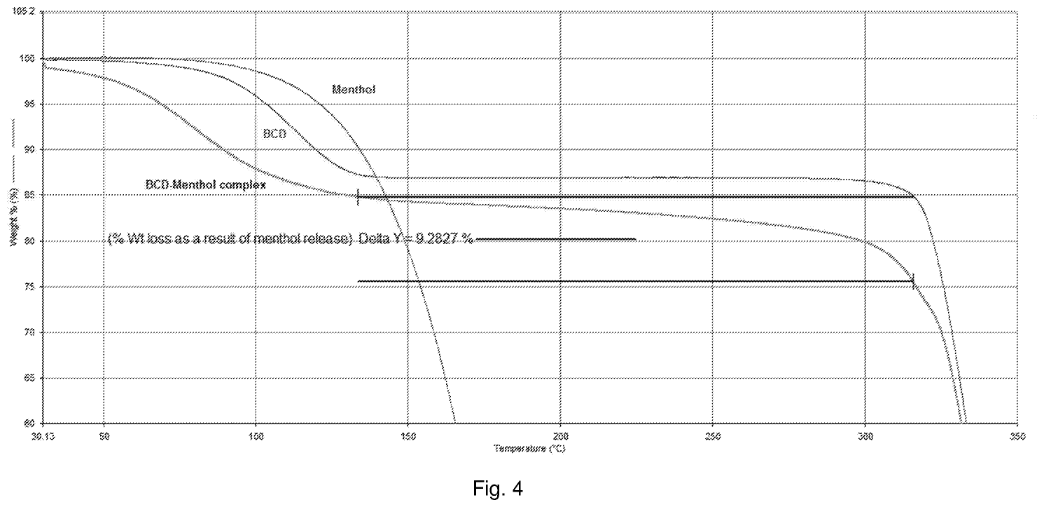

FIG. 4 shows the improved stability and delayed release of the menthol encapsulated in an encapsulating material comprising β-cyclodextrin. It is clear that the menthol encapsulated using β-cyclodextrin was more stable at higher temperatures. The encapsulated menthol release was delayed until the temperature reached about 150° C. to 300° C., whereas the unencapsulated menthol was released at about 100° C.

### Example 3

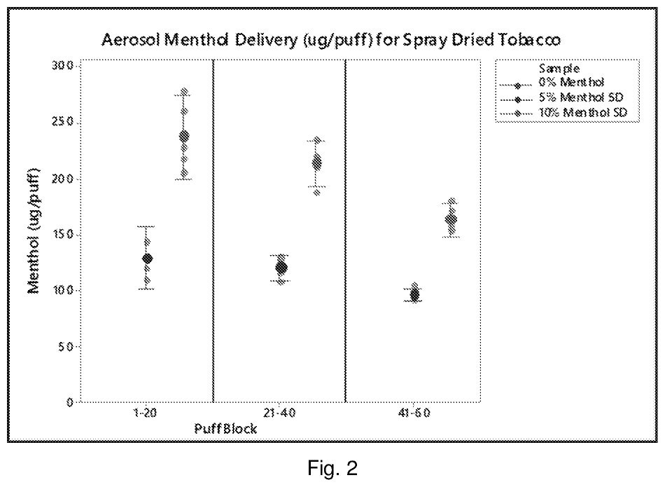

In a third example, tobacco with varying proportions of spray-dried menthol was tested in a THP device and the results are shown in FIG. 2. In this example, the encapsulation material comprised about 40 wt % of menthol and was spray dried. The aerosol-generating material was prepared via extrusion and was in the form of granules. The aerosol-generating material comprised 0, 5 or 10% of spray-dried menthol, as denoted in the legend of the graph. The menthol delivery was consistent with continued puffs on the device at about 100 μg/puff. There is no data for 0% menthol because there was no menthol to be released, and this was a control sample.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in future.

The invention claimed is:

1. An aerosol-generating material for use in an aerosol provision system, the aerosol-generating material having embedded therein a flavour encapsulated in an encapsulating material.

2. The aerosol-generating material as claimed in claim 1, wherein the aerosol-generating material is extruded, agglomerated or granulated to embed the encapsulated flavour therein.

3. The aerosol-generating material as claimed in claim 1, wherein the encapsulated flavour is menthol.

4. The aerosol-generating material as claimed in claim 1, wherein the encapsulated flavour is selected from dried vanilla, apple, amaretto, tiramisu, fruit of forest and mango.

5. The aerosol-generating material as claimed in claim 1, wherein the flavour is encapsulated in the encapsulating material by spray-drying.

6. The aerosol-generating material as claimed in claim 1, wherein the encapsulating material comprises a stabiliser.

7. The aerosol-generating material as claimed in claim 6, wherein the encapsulating material comprises a gum material.

8. The aerosol-generating material as claimed in claim 1, wherein the encapsulating material comprises one or more matrix-forming material selected from the group consisting of: sugar alcohols; carbohydrates; polymers such as gelatin, agar, PEG 2000-6000 and polyvinylpyrrolidone (PVP) (10k); and long chain fatty acids.

9. The aerosol-generating material as claimed in claim 8, wherein the matrix-forming material comprises sorbitol.

10. The aerosol-generating material as claimed in claim 1, wherein the encapsulating material is cyclodextrin.

11. The aerosol-generating material as claimed in claim 10, wherein the cyclodextrin is β-cyclodextrin or γ-cyclodextrin.

12. The aerosol-generating material as claimed in claim 1, further comprising a nicotine source.

13. The aerosol-generating material as claimed in claim 1, further comprising a binder.

14. The aerosol-generating material as claimed in claim 1, further comprising a pH modifier.

15. The aerosol-generating material as claimed in claim 1, comprising an aerosol-former.

16. A method for manufacturing an aerosol-generating material, comprising encapsulating a flavour in an encapsulation material and extruding, agglomerating or granulating the encapsulated flavour to form the aerosol-generating material.

17. The method as claimed in claim 16, wherein the encapsulated flavour is extruded with a nicotine source.

18. The method as claimed in claim 16, wherein the flavour is spray dried with the encapsulating material.

19. The method as claimed in claim 18, wherein the encapsulating material comprises 35-55% by weight of a stabiliser and/or 35-55% by weight of a gum material and/or 5-35% by weight of matrix-forming material.

20. The method as claims in claim 18, wherein the encapsulated flavour comprises 30-65% by weight of the flavour.

21. A consumable for use in an aerosol provision system comprising the aerosol-generating material as claimed in claim 1.

22. (canceled)
